(19) United States
(12) Patent Application Publication
(10) Pub. No.: US 2008/0109330 A1
(43) Pub. Date: May 8, 2008

(54) METHOD AND SYSTEM FOR CONSTRUCTING BUILDINGS

(75) Inventor: Antonio Torres, Sewickley, PA (US)

Correspondence Address: NOVA Chemicals Inc., Westpointe Center, 1550 Coraopolis Heights Road, Moon Township, PA, 15108, US

(73) Assignee: NOVA Chemicals Inc., Moon Township, PA (US)

(21) Appl. No.: 11/859,923

(22) Filed: Sep. 24, 2007

Related U.S. Application Data
(60) Provisional application No. 60/857,614, filed on Nov. 8, 2006.

(51) Int. Cl. G06F 19/00

(52) U.S. Cl. 705/29; 705/50

(57) ABSTRACT

A business method for constructing a building that includes providing a catalog of building components from suppliers in an established network of suppliers. Construction specifications for a building are inputted into a computer containing the database and components are selected from the building component database that correspond with the construction specifications. A database of compatiblized components that correspond with the construction specifications is produced and used to provide technical drawings of the components and construction drawings for the building. The individual component specifications and drawings are communicated to the building component suppliers who produce or obtain individual components conforming to the individual component specifications. A sequence for assembling the individual components to construct the building is determined and the components are transported to a construction site according to the sequence, where the building is then constructed.

This application claims the benefit of priority of U.S. Provisional Application Ser. No. 60/857,614, filed Nov. 8, 2006, entitled “Method and System For Constructing Buildings”, which is herein incorporated by reference in its entirety.

### BACKGROUND OF THE INVENTION

1. Field of the Invention

The present invention relates to methods and systems for constructing buildings.

2. Description of the Prior Art

Typically, when deciding to construct a building, a number of building designs, floor plans and elevations are considered. Such designs are often developed by a number of architects and/or building designers and can range from small utilitarian structure to large amenity packed designs. In many cases, as a final building design is selected, much time and effort is required to solve compatibility problems that arise when putting together the various components of a building. For example, a desired floor system may not interface properly with the chosen foundation and wall systems selected for a building. In this case, time-consuming modifications are required to provide a building plan that will meet local construction code approvals.

Further, many things can, and do, go wrong during the design and construction of a new building. In many cases, these occurrences are a result of less than perfect communications between those requesting parts and information, those directing the construction, and those performing the construction. Often, the various contractors and suppliers are fragmented with no unifying organization. Typically, all parties involved with a construction project have their own ideas about how the job should be scheduled, how the work should be performed, and what the project should look like when it is finished.

The end result is often building components that do not interface correctly, routes for providing utilities being blocked, and/or aesthetically undesirable corrections being implemented.

Thus, there is a need in the art for a method of constructing buildings that anticipates and solves the above-described problems prior to constructing a building at a construction site.

### SUMMARY OF THE INVENTION

The present invention provides a method for constructing a building, that includes:
establishing a network of building component suppliers;
providing a catalog of building components from each supplier as a computer-based database;
inputting construction specifications for a building into a computer containing the building component database;
selecting components from the building component database that correspond with the construction specifications;
generating a database of components that correspond with the construction specifications;
producing construction drawings for the building;
ordering building components from one or more building component suppliers;
producing or obtaining individual components by the building component suppliers;
determining a prescribed sequence for assembling the individual components to construct the building according to the construction drawings;
transporting individual components to a construction site in the prescribed sequence; and
constructing the building in the prescribed sequence.

The present invention also provides a system that includes:
a user interface to provide a computer-based database of building components from a plurality of building component suppliers in a network of building component suppliers, and to receive construction specifications for a building to be constructed;
a building component supplier interface to receive orders for one or more building components for each of one or more of the building component suppliers; and
a general contractor interface to receive a sequence for receiving a plurality of building components and a sequence for combining said building components to construct a building.

The present invention further provides a machine readable medium having instructions stored thereon which when executed by a processor cause the processor to perform operations that include:
establishing a database of building components available from a network of building component suppliers;
receiving construction specifications for a building to be constructed from a user;
selecting building components from the database of building components that correspond with the construction specifications;
determining a prescribed sequence for assembling the individual building components to construct the building
ordering building components from one or more building component suppliers to arrive at a construction site according to the prescribed sequence; and
communicating the prescribed sequence for assembling the building components to a general contractor responsible for constructing the building.

### DESCRIPTION OF THE DRAWINGS

FIG. 1 illustrates a computer networked environment in which embodiments of the methods and systems for constructing buildings described herein can be implemented;

FIG. 2 illustrates transactions between participants in the methods and systems for constructing buildings described herein; and

FIG. 3 illustrates a generalized flow of actions taken by participants according to embodiments of the methods and systems for constructing buildings described herein.

### DETAILED DESCRIPTION OF THE INVENTION

The present invention provides a method of doing business that allows a user to select an architectural design layout, which can then be customized with regard to the size, shape and dimensions of the various construction components used in constructing a building. The architectural design layouts can be provided via software from a disk or via an Internet connection. For those customers with Internet capabilities, access to the present method is convenient and provides an efficient and time saving method to design and manufacture a building and/or housing units.

In a non-limiting embodiment of the invention, a customer selects an architectural design for a building. The architectural design includes the unique features of each building component used to construct the building. The architectural design is loaded into a processing unit that translates the design into instructions for individual suppliers. The instructions direct the individual suppliers to produce defined construction components and a schedule for delivering the construction components to a defined construction site.

The architectural design can include, as non-limiting examples the dimensions of and the location of openings and holes required in each construction component for routing utilities, the dimensions of each construction component to include thickness, width, height, spacing, dimensions and shape for each component.

The processing unit can be any computer or device capable of reading instructions and translating them into instructions for building component suppliers.

In another embodiment of the invention, an interactive computer program can be used to provide the architectural designs described above. In an embodiment of the invention, the architectural design can be inputted using a series of computer screen menus, where a user selects choices made available on a computer screen. When the design button is selected, menu screens appear for additional choices for modifying the various construction components. Selecting any of the menus directs to another screen where specific architectural design features as described above can be inputted as well as the number of components required that have those features. Upon selection, additional customized components can be inputted. The user then verifies the order by selecting an “order plans” button. The instructions are then relayed to a central processing facility and each of the requested number of components having each of the architectural design features are produced and scheduled for delivery to a specified construction site. In an embodiment of the invention, the components are automatically labeled and marked for placement in their proper position.

In a further embodiment, the customer requests access to an interactive program that steps the customer through the design process. Once the design is complete, the customer can save the design for future use. The customer can also choose to submit the design for an order.

The use of a design program on an Internet site benefits the manufacturer in a variety of ways including a method of gathering customer profiles that can later be used for mailings, etc. In addition, an Internet site that includes this unique method of doing business reaches worldwide and generates name recognition for the manufacturer, particularly where the construction panel manufacturer is the only manufacturer to offer an accessible and convenient method of designing and ordering composite construction panels.

The design program of the invention provides an advantage for the user in his or her own business in that it raises the level of professionalism of the user by allowing prompt and on-the-spot service for his or her own customers. For example, a customer can bring a sketch or layout for an architectural design requesting components that can be used in the layout or design. In response, the customer can utilize the design program to build a series of components on a computer screen with the customer by his side, and explain to the customer the benefits of the custom components. This process provides a first rate service to the customer, eliminates guessing, increases interaction between the user and the end customer, and enhances business reputation in the field.

As used herein, the term “building component” means an article used in constructing a building. Non-limiting examples of such articles include, but are not limited to insulated concrete forms (“ICF”), wall panels, tilt-up walls, doors, windows, floor systems, roof systems, siding, drywall, fasteners, concrete, and the like.

Specific examples of building components that can be included in the building component database include, but are not limited to ICF's made all or in part from molded EPS as disclosed for example in U.S. Pat. Nos. 5,333,429; 5,390,459; 5,566,518; 5,568,710; 5,657,600; 5,709,060; 5,787,665; 5,822,940; 5,845,449; 5,887,401; 6,098,367; 6,167,624; 6,170,220; 6,235,367; 6,314,697; 6,318,040; 6,336,301; 6,363,683; 6,438,918; 6,526,713; 6,588,168; 6,647,686 and 6,820,384; and in U.S. Patent Application Publication Nos. 2002/0116889 and 2003/0005659 and various building panels as disclosed in WO 2006/091882; WO 200/6091864; WO 2006/091792; WO 2004/101905; WO 2002/035020; EP 0 459 924 and U.S. Pat. Nos. 6,298,622; 6,235,367; 6,167,624; 6,098,367; 5,822,940; 5,787,665 and 5,333,429, the relevant disclosures of which are herein incorporated by reference. However, it should be stressed that all types of building components will be included in the building component database as indicated above.

In the present method for constructing a building, a network of building component suppliers is established. Typically, the network will include one or more entities capable of providing assigned building components to construction sites as instructed. Desirably, the building component suppliers are able to communicate electronically, non-limiting example of such electronic communications being effected by internet communications, electronic mail, text messaging, touch-tone telephone, modem, and combinations thereof.

As used herein, the term “internet communications” refers to communications accomplished via the World Wide Web, a publicly accessible network of interconnected computer networks that transmit data by packet switching using the standard Internet Protocol (IP). It is a “network of networks” that carries various information and services, such as electronic mail, online chat, file transfer, interlinked Web pages and other documents.

As used herein, the term “text messages” refers to Short Message Service (SMS) or other services, often available on digital mobile telephones (and other mobile devices, e.g., a Pocket PC, or occasionally even desktop computers) that permits the sending of short messages between mobile phones, other handheld devices and even computers and landline telephones.

As used herein, the terms “electronic mail” or “e-mail” or “email” refer to a method of composing, sending, storing, and receiving messages over electronic communication systems.

As used herein, the term “modem” refers to a device that modulates an analog carrier signal to encode digital information, and also demodulates such a carrier signal to decode the transmitted information. The goal is to produce a signal that can be transmitted easily and decoded to reproduce the original digital data. Modems can be used over any means of transmitting analog signals, from driven diodes to radio. A non-limiting example, a modem can covert the digital ‘1s and 0s’ of a personal computer into sounds that can be transmitted over telephone lines and once received on the other end, converts those sounds back into 1s and 0s.

The suppliers provide a plurality of building components, all of which are included in a catalog of building components. In the present method, the catalog of building components is provided as a computer-based database and includes all building components available to the network from each supplier.

In some embodiments of the invention, at least some of the building component suppliers are the exclusive or preferred provider of one or more particular building components.

As used herein the term “catalog of building components” refers to an organized, detailed, descriptive list of building components, arranged systematically that can be used in the present method. Non-limiting examples of details that can be included in the catalog regarding individual building components include dimensional ranges, materials of construction, material incompatibilities, code approvals, physical property specification, supplier, supplier location(s), transportation requirements, and the like.

As used herein, the term “database” refers to a collection of logically related data designed to meet the information needs of one or more users. For better retrieval and sorting, each record in the database can be organized as a set of data elements (facts). In the present invention, the building components database is a collection of records stored in a computer in a systematic way, so that a computer program can consult it to answer questions. The items retrieved in answer to queries become information that can be used to make design decisions. The computer programs used to manage and query the database are referred to herein as “database management systems” or “DBMS”.

In the present method, construction specifications for a building are provided by a user and inputted (entered via key strokes or another communication method as described above) into a computer containing the building component database.

As used herein, the term “construction specifications” refers to a set of requirements for the building that is to be constructed. The requirements can include system related requirements for the building as well as test requirements that detail what prescribed performance parameters a building component must meet. Non-limiting examples of performance parameters can include ASTM test methods, Florida building code requirements relative to hurricane damage avoidance, California's building codes for earthquake safety, and fire safety codes.

In the present method, the catalog of building components database includes all specifications that each building component is known to meet. Thus, once construction specifications are identified, the building components in the building component database that correspond with the identified construction specifications can be selected. When multiple components meet the identified construction specifications, secondary criteria, such as cost, materials of construction, etc. can be selected to make a final selection.

Each of the selected building components are compared for dimensional compatibility. In other words, where two or more components interface, the dimensions are compared to determine if the components will “fit together”. This comparison identifies situations that need to be addressed before components are transported to a construction site so on-site delays are minimized. Thus, incompatibly dimensioned components are identified.

Once identified, the incompatible component dimensions are adjusted to make the previously incompatible components compatible with each other. This adjustment routine can take into consideration authorized dimensional changes that can be made to a component, which can be included in the building component database. If authorized dimensional changes are not included or the required changes are outside of the authorized range, then a message is provided to the user communicating the component dimension incompatibility. Once this message is received, the component supplier is notified and a component meeting the desired dimensions is requested. If the re-dimensioned component can be provided, it is added to the building component database. If the re-dimensioned component cannot be provided, then the building design is altered to include the component in the available dimensions.

Once all of the building components are in dimensional agreement, they are listed in a database of compatible components that correspond with the construction specifications that is generated, typically in a computer. The database of compatible components includes all of the building components for a specific building to be constructed. Typically, a plurality of such databases will reside at the same time as multiple building projects can be worked on simultaneously.

As used herein, the term “computer” refers to any of a number of known machines adapted to manipulate data according to a list of instructions often referred to as a program. The computers used in the present method can include super computing facilities, personal computers, portable computers, laptop computers, and embedded computer, which can be used to control another device.

The computer, cpu or other data processing unit can then produce technical drawings for each of the components in the database of compatible components. As used herein, the term “technical drawings” refers to any reproduction, blueprint, or computer-generated image showing a plan or image documenting an architectural or an engineering design of one or more individual building components. The use of any known computer-based tools such as CAD can be used to create the technical drawings from computes as described herein.

The computer, cpu or other data processing unit can then produce construction drawings for the building. As used herein, the term “construction drawings” refers to any reproduction, blueprint, or computer-generated image showing a plan or image documenting an architectural or an engineering design showing the interrelation of one or more individual building components as part of an overall building design. As a particular example, construction drawings can show how individual building components fit and/or work together to construct the building. The use of any known computer-based tools such as CAD can be used to create the technical drawings from computes as described herein.

The individual component specifications and technical drawings of each building component in the database of compatible components and number of each components required can then be communicated to respective building component suppliers. Typically, the component specifications will be communicated using electronic communications, facsimile transmission, courier or mail service.

The building component suppliers in the network with which orders have been placed then produce or otherwise obtain the assigned individual components that conform to the individual component specifications.

The computer, cpu or other data processing unit determines a sequence for assembling the individual components to construct the building according to the construction drawings and generates a prescribed sequence. Each of the building component suppliers in the network with which orders have been placed is provided a time and place window for the arrival of each of its assigned components at a construction location.

The individual building components are then transported to the construction site to arrive in the prescribed sequence from the respective building component suppliers. Transportation can include any suitable mode, a non-limiting example of which includes vehicular transportation. As used herein, the term “vehicular transportation” refers to all non-living modes of transportation and includes, without limitation bicycles, cars, trucks, tailors, motorcycles, trains, ships, and aircraft whether propelled by machines or animals, the latter exemplified by chariots, ox-cart, and/or horse-drawn wagons.

As each building component arrives at the construction site, the building components are used to construct the building in the prescribed sequence.

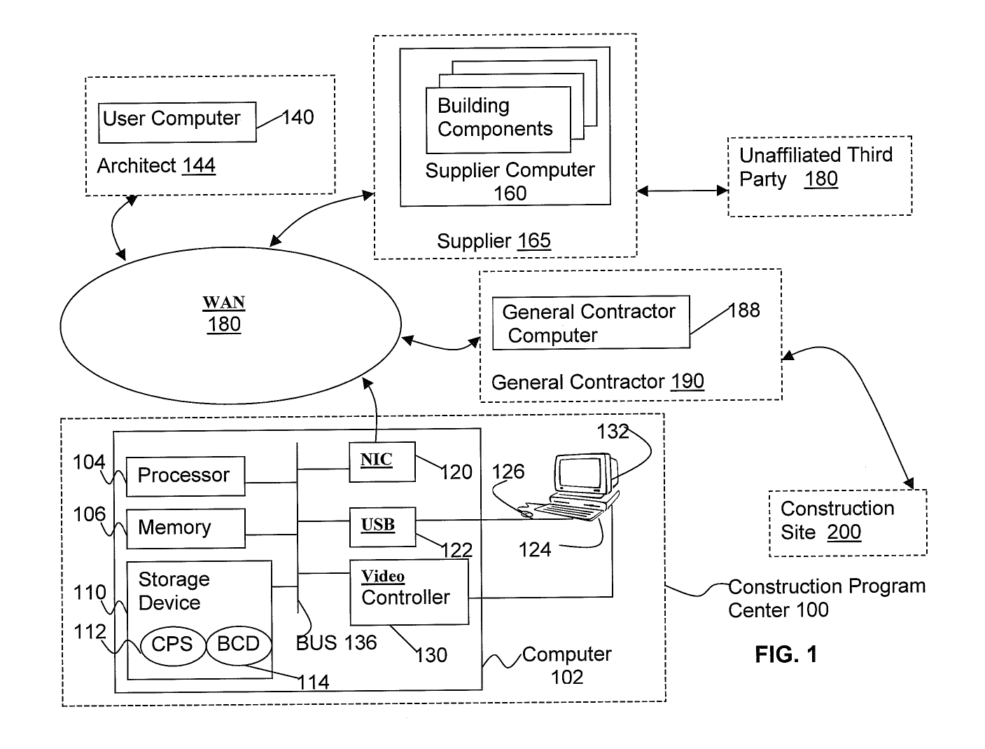

FIG. 1 illustrates a computer networked environment in which many embodiments of the method for constructing a building described herein can be implemented. At the heart of the methods and systems described herein is a construction program center (CPC) 100. In one embodiment, the methods described herein can be implemented as software referred to as construction program software (CPS) 112. The CPS can be executed by a computer such as computer 102. Computer 102 can be any computer that can execute software programs. Computer 102 generally has features and components commonly found in server computers. In one embodiment, computer 102 includes processor 104 and memory 106. Processor 104 can be any computer processor, and memory 106 can be any random access memory (RAM) or other readable and writeable memory device. Processor 104 executes the CPS utilizing memory 106. Information, including the CPS can be read from and/or written to storage device 110. Storage device 110 can be any device by which a machine can read from a machine readable medium including, but not limited to, a magnetic disk drive such as a hard disk drive, a magnetic tape device such as a digital audio tape (DAT) device, an optical disk drive such as a readable and writeable compact disk (CDRW) drive and a readable and writeable digital versatile disk drive (DVD), stick and card memory devices, silicon devices such as electronically erasable programmable memory (EEPROM) and read only memory (ROM) devices, etc. that can be internal, such as storage device 110 and, in other embodiments, directly coupled, accessible locally or remotely via a network, and accessible via electrical, optical, acoustical or other form of propagated signals (e.g., carrier waves, infrared signals, digital signals, etc.). In one embodiment, storage device 110 can be a plurality of disk drives comprising a disk array or other configuration.

Processor 104 can communicate instructions to video controller 130 to display text, images, etc. on display monitor 132. Video controller 130 can be any video graphics controller, and display monitor 132 can be any display monitor, including, but not limited to, a cathode ray tube (CRT) display monitor and a thin film transistor (TFT) display screen. A CPC user can access computer 102 via any computer input device, such as, for example, keyboard 124 and mouse 126 which are coupled to the processing unit by, in one embodiment, Universal Serial Bus (USB) controller 122.

Computer 102 can also include at least one network interface controller (NIC) 120 which allows for communication with a wide area network (WAN) 180 such as the Internet. As used herein, WAN is deemed to include the Internet, public switched telephone networks (PSTN), satellite networks, or any other network covering a substantial geographical area. In various embodiments, information can be received through NIC 120 via land lines such as T1 lines, T3 lines, coaxial cable, Ethernet, twisted-pair, fiber optic such as a Synchronous Optical Network (SONET), or other physically present connection. In other embodiments, the connection via NIC 120 can be wireless in the form of microwave, satellite, radio wave and the like. The format of the data sent by and received by the CPC can be any data format including, for example, the Transmission Control Protocol (TCP), Universal Datagram Protocol (UDP), Internet Protocol (IP) Packets, etc.

In one embodiment, the CPS can include Internet web site software that provides for the communicating and display of Internet web pages on remote computers and remote computing devices. The Internet software can be written in any well known computer language, such as, for example, the hypertext mark-up language (HTML), Java server pages (JSP), the extensible mark-up language (XML), etc. and can be communicated via well known communications protocols, such as, for example, the hypertext transfer protocol (HTTP). Server communications and transactions can be supported by secure HTTP (S-HTTP), secure sockets layer (SSL) encryption, and other well known and/or priority security techniques.

To maintain information about the various building component suppliers and the building components they provide to the CPC, one or more databases, can be included in the CPC and stored on storage device 110, such as, for example, the building components database (BCD) 114. These databases can be relational, can be programmed using the structure query language (SQL), or can be constructed according to any well known database languages and techniques.

Processor 104, memory 106, storage device 110, video controller 130, USB controller 122, and NIC 120 are coupled to one another via and communicate with one another over bus 136. Bus 136 can be any bus that provides for communication of and between components within a computer. Although only one bus is depicted, multiple buses can be used in computer 102. In addition, other components and controllers (not depicted) and multiple instances of depicted components and controllers can be included in computer 102.

CPC 100 can include a single computer, such as computer 102 as shown, or can include multiple computers arranged as a group, cluster, sub-network, local area network (LAN) or other group of multiple computers. CPC 100 can also include other well known devices, such as, for example, gateways, bridges, routers, firewalls, etc. which can be included in a computer network environment. So as not to obscure the focus of the description, these and other well known devices are not depicted.

In various embodiments, each of user computers 140, Supplier computers 160, and general contractor computer 188 can be a server computer similar to computer 102, a group of computers including, for example, a sub-network, cluster, LAN, etc, or can be a single personal computer. User computers 140 can be computers of individuals who may be affiliated with an architect 144 or other building design entity. User computers 140 are typically personal computing devices having components similar to those described regarding computer 102. In addition, user computers 140 can be any computing device, such as, for example, personal computers, portable computers, laptop computers, computing tablets, set-top boxes, cellular telephones, personal digital assistants (PDAs) and the like. While as discussed below, it is contemplated that users can choose to initiate building designs over WAN 180, in one embodiment, the building constructing method is expected to accommodate any common form of communicating information.

As used herein, the term “general contractor” refers to an organization or individual that contracts with an owner, user, architect, building designer, or other entity to construct a building. Typically, the general contractor is the signatory as the builder of the prime construction contract for a project. The general contractor is responsible for the means and methods to be used in the construction of the building in accordance with the contract documents, which in the present invention includes constructing the building by following the sequence for combining the building components to construct the building as described herein.

In one embodiment, supplier 165 receives instructions to supply building components via WAN 180 and communicates to unaffiliated third party 180 to provide one or more of the building components by transferring data over WAN 180 or by direct communication. For example, supplier computer 160 can have a direct connection to a computer of unaffiliated third party 180. The direct connection can be made by leased line, dial up connection and the like.

Similarly, general contractor 190 can receive information as to the scheduled delivery of building components via WAN 180 and provide that information to construction site 200 via telephone, walkie-talkie or other known communication devices.

In various embodiments, architects 144 or other building designers can be connected to WAN 180 by dedicated hardware remotely distributed to permit architects 144 or other building designers to access CPC 100. User computers 140 can include a general purpose computer with appropriate resident software, which in one embodiment can permit establishment of a virtual private network between the architects 144 or other building designers and CPC 100.

The CPC can provide various interfaces to each of the participating entities in the building construction system. CPC 100 can provide a web site with various web pages that allow architects 144 and other building designers, suppliers 165 and general contractors 190 to access information concerning the building components used in the present method of constructing a building and the buildings that can be constructed using the present method. For example, the CPC can provide an Internet web interface by which the individuals can, depending on their authorization level, view the current list of building components in BCD 114 or the types of buildings that can be constructed using the components in BCD 114 as well as the most up to date schedule for delivery of building components to construction site 200. The web site interface can also allow authorized individuals to approve or otherwise authorize modifications to building component specifications or approve new building plans using existing building components.

Thus, a system is provided that includes a user interface to provide a computer-based database of building components from a plurality of building component suppliers in a network of building component suppliers, and to receive construction specifications for a building to be constructed; a building component supplier interface to receive orders for one or more building components for each of one or more of the building component suppliers; and a general contractor interface to receive a sequence for receiving a plurality of building components and a sequence for combining the building components to construct a building.

Additionally, a machine readable medium is provided that has instructions stored thereon which when executed by a processor cause the processor to perform operations that include: establishing a database of building components available from a network of building component suppliers; receiving construction specifications for a building to be constructed from a use; selecting building components from the database of building components that correspond with the construction specifications; determining a prescribed sequence for assembling the individual building components to construct the building; ordering building components from one or more building component suppliers to arrive at a construction site according to the prescribed sequence; and communicating the prescribed sequence for assembling the building components to a general contractor responsible for constructing the building.

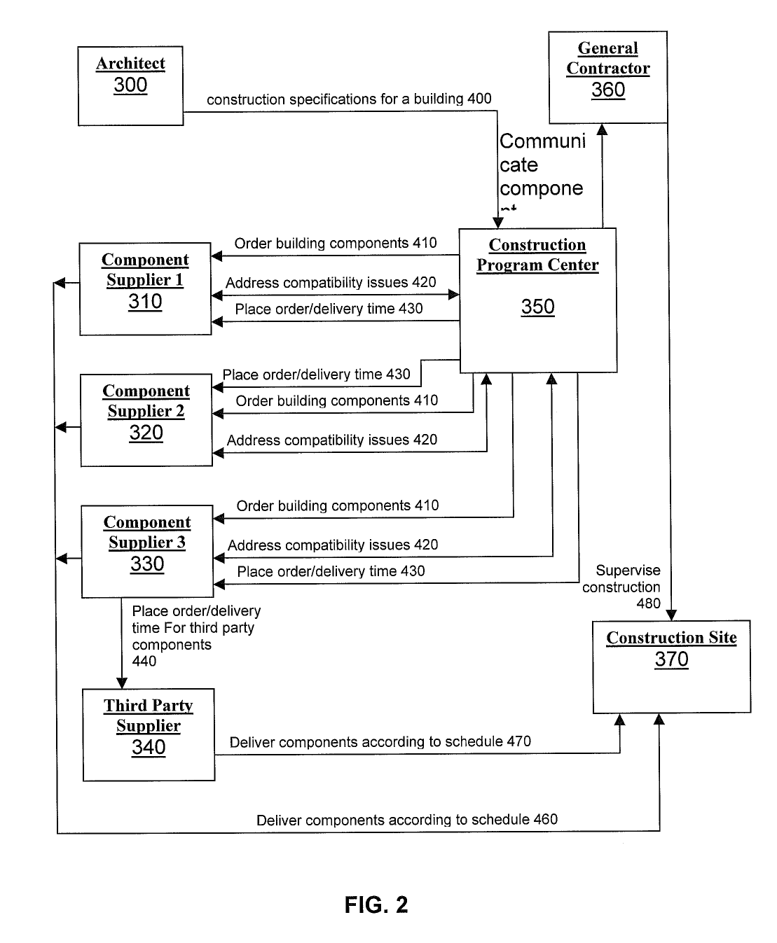

FIG. 2 illustrates the transactions between participants in the present method for constructing a building. According to the systems and methods described herein construction specification data for a building 400 are inputted into a computer containing a building component database at the construction program center (CPC) 350 as described above by a user 300, for example an architect or other building designer. The computer then compares the specifications against construction specifications in the building component database to select components that most closely conform to the construction specifications. CPC then orders building components 410 from the component supplier indicated in the building component database. This transaction is carried out for each component, which will typically result in orders being placed with a plurality of component suppliers, shown as component supplier 1 310, component supplier 2 320 and component supplier 3 330. In the instances where the dimensions of individual components are not compatible with each other, CPC 350 will address compatibility issues 420 with the respective component suppliers and mutually agree on modified dimensions for incompatible components such that the formerly incompatible components are modified to become dimensionally compatible. Once all components are compatible, a database of compatible components is assembled in CPC 350 and is used to develop a building construction sequence and place orders with specified delivery times 430 for each building component with its respective building component supplier for delivery to construction site 370.

In some embodiments of the invention, a building component supplier (shown as building component supplier 3 330) will obtain a building component from third party supplier 340. In this embodiment, component supplier 3 330 will place an order for the building component with the specified delivery time 440 to construction site 370.

CPC 350 coordinates with general contractor 360, who is responsible for the assembly of the building by combining building components in the specified sequence. In order to facilitate the desired construction sequence, CPC 350 communicates the component delivery schedule 450 to general contractor 360, who can then supervise construction 480 at construction site 370. Thus as building components are delivered according to schedule 460 to construction site 370 from component suppliers 310, 320 and 330 and third party supplier 340, general contractor 360 can supervise construction 480 of the building by having the building components combined as they arrive at construction site 370. In this way, a just-in-time construction method can be facilitated, which shortens the overall length of time to construct a building, reduces inventory at the construction site, reduces material carrying costs as well as the overall cost to construct the building.

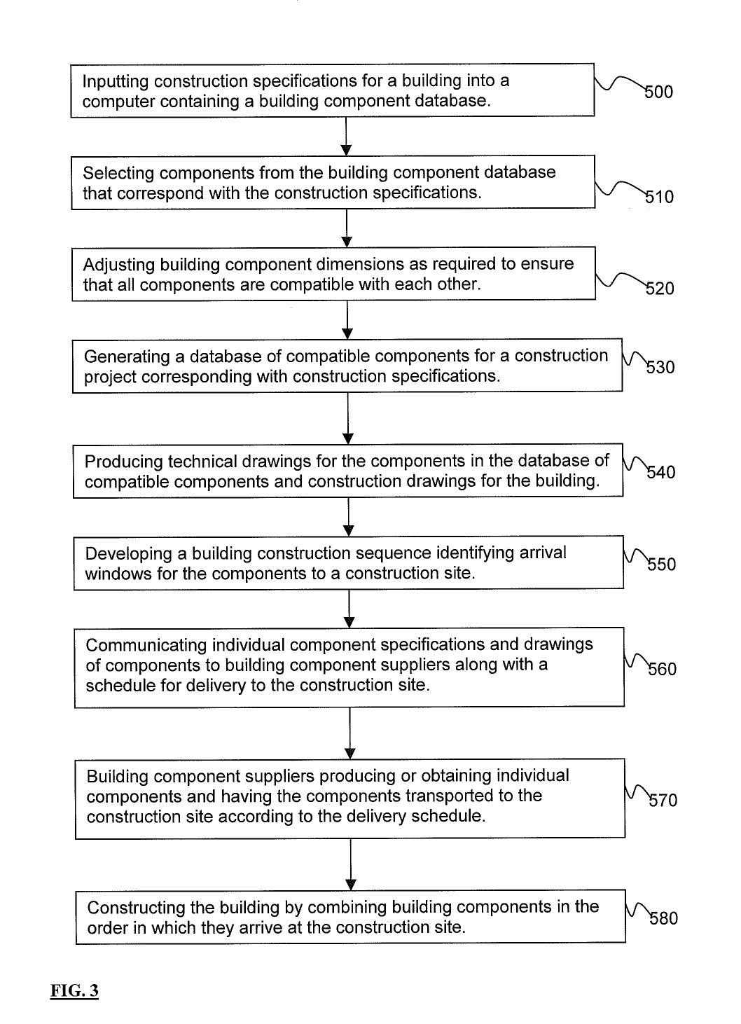

FIG. 3 illustrates a generalized flow of actions taken by participants according to the method and system of constructing a building described herein. According to the systems and methods described herein, construction specification data for a building are inputted into a computer containing a building component database 500, typically by an architect or other building designer. The computer then compares the specifications against construction specifications in the building component database to select components that most closely conform to the construction specifications 510. In the instances where the dimensions of individual building components are not compatible with each other, the CPC will communicate with the respective component suppliers and mutually agree on modified dimensions for incompatible components and go about adjusting building component dimensions as required to ensure that all components are compatible with each other 520. In this way, the formerly incompatible components are modified to become dimensionally compatible. Once all components are compatible, a database of compatible components is generated for a given construction project that corresponds to the construction specifications 530.

Technical drawings are then produced in the CPC for the building components in the database of compatible building components as well as construction drawings for the building 540. A building construction sequence is also developed that identifies arrival windows for the building components to be delivered to a construction site 550. In this way, all building components are identified, the sequence or order in which the building components are to be assembled is identified and based on the estimated time to add each building component to the building during the construction sequence, timing for each building component to arrive at the construction site is identified. The delivery window for each component is then defined, based on minimizing the length of time a component would sit at a construction site prior to being added to the building under construction and taking into consideration typical transportation times from the supplier and any potential transportation delays. This information would typically be included in the building component database for each building component and component supplier.

The individual component specifications and drawings of components are communicated to building component suppliers along with a schedule for delivery to the construction site 560 by the CPC. The communication can be accomplished by placing purchase orders for the building components from the component suppliers. These transaction are typically carried out for each component, which will typically result in orders being placed with a plurality of component suppliers.

With the above information in hand, the building component suppliers can then produce or otherwise obtain the individual building components and have the components transported to the construction site according to the delivery schedule 570. The building is then constructed by having the building components combined in the order they arrive at the construction site 580.

In embodiments of the invention, the CPC and the various computers, databases and software therein can be used as a management tool to simplify the work at a construction site, including specifying what order to combine components and when to deliver components to the construction site. The method of doing business according to the invention reduces the time and cost to design and build standardized and customized buildings.

Another advantage to the present method is the improvement in compatibility between components that is provided. The dimensional compatibility of the building components drives the ease of use and erection in the present method and saves time and money for all parties involved in the present construction method.

Compatibility also enables a design capability that works across all building component suppliers and building components leading to the establishment of a building design network. Software in the CPC computers allows the building components in the building component database to be used in the design of any structure. The software takes the different building components of the building component suppliers and engineers solutions for users in a unique manner. The software platform provides the basis for continuous improvement of building components and provides a system solution for designing buildings.

Additionally, the present method minimizes issues with contractors and suppliers being fragmented by providing a unifying organization. In the present method, the CPC provides logistical management to a construction project detailing how a construction job is to be scheduled, how and when the work is to be performed, and what the project should look like when it is finished.

The present invention has been described with reference to specific details of particular embodiments thereof. It is not intended that such details be regarded as limitations upon the scope of the invention.

We claim:

1. A business method for constructing a building, comprising:
establishing a network of building component suppliers;
providing a catalog of building components from each supplier as a computer-based database;
inputting construction specifications for a building into a computer containing the building component database;
selecting components from the building component database that correspond with the construction specifications;
generating a database of components that correspond with the construction specifications;
producing construction drawings for the building;
ordering building components from one or more building component suppliers;
producing or obtaining individual components by the building component suppliers;
determining a prescribed sequence for assembling the individual components to construct the building according to the construction drawings;
transporting individual components to a construction site in the prescribed sequence; and
constructing the building in the prescribed sequence.

2. The method according to claim 1 comprising the steps of
comparing building component dimensions for compatibility;
identifying incompatibly dimensioned components;
adjusting incompatible component dimensions to make incompatible components compatible with each other; and
generating a database of compatible components that correspond with the construction specifications to be used as the database of components.

3. The method according to claim 1 comprising the step of
producing drawings for the components in the database of compatible components.

4. The method according to claim 1 comprising the step of communicating individual component specifications and drawings of components in the database of compatible components to building component suppliers.

5. The method according to claim 1, wherein the construction specifications are provided by a computer program that provides architectural designs.

6. The method according to claim 1, wherein the building component database includes data relating to one or more building components selected from the group consisting of insulated concrete forms (“ICF”), wall panels, tilt-up walls, doors, windows, floor systems, roof systems, siding, drywall, fasteners, and concrete.

7. The method according to claim 1, wherein the building component database includes data for each building component including one or more selected from the group consisting of shape, thickness, width, height, spacing, dimensional ranges, materials of construction, material incompatibilities, code approvals, physical property specifications, supplier(s), supplier location(s), transportation requirements, and combinations thereof.

8. The method according to claim 1, wherein inputting and/or ordering are done via an electronic communications methods selected from the group consisting of internet communications, electronic mail, text messaging, touch-tone telephone, modem, and combinations thereof.

9. The method according to claim 1, wherein the computer includes a processor, a storage device and construction program software.

10. The method according to claim 1, wherein the storage device is selected from the group consisting of magnetic disk drives, magnetic tape devices, optical disk drives, stick memory devices, card memory devices, electronically erasable programmable memory, read only memory devices, and combinations thereof.

11. The method according to claim 1, wherein the computer includes at least one network interface controller for communication with a wide area network.

12. The method according to claim 1, wherein the construction program software includes Internet web site software that provides for the communicating and display of Internet web pages on remote computers and remote computing devices.

13. The method according to claim 12, wherein the Internet web site software is written in a computer language selected from the group consisting of hypertext mark-up language (HTML), Java server pages (JSP), and the extensible mark-up language (XML).

14. The method according to claim 12, wherein the Internet web site software is communicated via hypertext transfer protocol, optionally supported by secure HTTP and/or secure sockets layer (SSL) encryption.

15. The method according to claim 1, wherein the step of constructing the building in the prescribed sequence includes providing a general contractor responsible for the assembly of a building with a component delivery schedule that outlines the arrival date and time for each building component and the sequence for combining building components to construct the building.

16. The method according to claim 1 wherein at least some of the building component suppliers are the exclusive or preferred provider of one or more particular building components.

17. A system comprising:
a user interface to provide a computer-based database of building components from a plurality of building component suppliers in a network of building component suppliers, and to receive construction specifications for a building to be constructed;
a building component supplier interface to receive orders for one or more building components for each of one or more of the building component suppliers; and
a general contractor interface to receive a sequence for receiving a plurality of building components and a sequence for combining said building components to construct a building.

18. A machine readable medium having instructions stored thereon which when executed by a processor cause the processor to perform operations comprising:
establishing a database of building components available from a network of building component suppliers;
receiving construction specifications for a building to be constructed from a use;
selecting building components from the database of building components that correspond with the construction specifications;
determining a prescribed sequence for assembling the individual building components to construct the building
ordering building components from one or more building component suppliers to arrive at a construction site according to the prescribed sequence; and
communicating the prescribed sequence for assembling the building components to a general contractor responsible for constructing the building.
